(19) United States
(12) Patent Application Publication
(10) Pub. No.: US 2012/0183646 A1
(43) Pub. Date: Jul. 19, 2012

(54) CARBOHYDRATE-ENRICHED PLANT PULP COMPOSITION

(75) Inventor: Adrianus Marinus Maria de Laat, Breda (NL)

(73) Assignee: Koninklijke Cooperatie Cosun U.A.

(21) Appl. No.: 13/384,131

(22) PCT Filed: Jul. 16, 2010
(86) PCT No.: PCT/NL2010/050460

§ 371 Date: Mar. 28, 2012

(30) Foreign Application Priority Data
Jul. 17, 2009 (EP) 09165786.6

(51) Int. Cl. A23L 1/214; A23L 1/216; A23L 1/10; A21D 13/08; A23C 9/154; A23L 1/16; A23L 1/318; A23L 1/212; A23L 1/164

(52) U.S. Cl. 426/52; 426/639; 426/637; 426/618; 426/619; 426/620; 426/580; 426/557; 426/641; 426/556

(57) ABSTRACT

The invention pertains to a plant or vegetable pulp composition comprising: a) plant or vegetable pulp comprising 5-30 wt % cell wall materials comprising or consisting of cellulose, hemicellulose, lignin and/or pectin, and/or fragments and/or hydrolysates thereof, wherein said pulp is obtained by disrupting plant or vegetable cell membranes and removing at least part of the intracellular content; b) 45-85 wt % of one or more water-soluble carbohydrate(s) selected from the group consisting of inulin, oligofructose, fructo-oligosaccharide, galacto-oligosaccharide, glucose, maltose, maltodextrins, polydextrose, sucrose, fructose, lactose, isomaltulose and polyols, and/or combinations thereof; and c) 5-25 wt % water, all numbers based on total weight of said composition. The invention also pertains to the method of preparing such a composition, and the use in (human) food applications.

### FIELD OF THE INVENTION

The present invention pertains to a food composition comprising carbohydrate-enriched residue or pulp from extracted plant material, and the products and applications derived there from, and to the method for preparing such compositions.

### BACKGROUND OF THE INVENTION

The isolation of valuable food ingredients from raw plant materials is known in the art. Cell membranes are disrupted mechanically, thermally or otherwise. Following disruption, food ingredients of the biological material are recovered. Examples of such isolation processes are the extraction of sucrose from sugar beet, and inulin from chicory root and Jerusalem artichoke tuber. Other examples are the extraction of juice or oil from fruits and vegetables, the harvesting of starch granules from potato, the enzyme-mediated extraction of starch-derived sugars from barley in beer production, the fermentation-mediated extraction of carbohydrates from grapes or apple (in wine or cider production respectively) and from grains (in beer or alcohol production).

The isolation of said food ingredients from plant material leaves as main by-product a moist plant residue comprising predominantly the carbohydrates cellulose, hemicellulose, lignin and/or pectin, as well as minor amounts of protein, low-molecular weight carbohydrates and minerals. In the past, efforts have been directed towards utilizing the plant extraction residue that results from sucrose, starch and inulin isolation from vegetable material in particularly animal feeds. U.S. Pat. No. 6,391,375 discloses a pet food comprising the pulp that was obtained following the inulin extraction of chicory root, resulting in an inulin content of the chicory to a maximum of 10% when the pulp was dried to have a 10% moisture level.

However, where it concerns human food, the use of tissue material of inulin-containing plants has so far been limited to processing the storage organ (root or tuber) as a whole, without a preceding inulin extraction. U.S. Pat. No. 4,871,574 discloses the preparation of flour from Jerusalem artichoke or similar inulin-containing plants by maceration, heating and spray-drying, resulting in a flour comprising a mixture of mono- and disaccharides, low molecular weight oligosaccharides and high molecular weight polysaccharides for application in e.g. bread and dietary products. EP 850.569 discloses a cereal product comprising a gelatinized starch matrix containing inulin-rich plant material such as chicory root or Jerusalem artichoke. In this product, the gelatinization process is believed to remove the bitter flavour that is usually associated with these plants.

Several processes have been disclosed in the art that involve drying, generally followed by milling, grinding or pulverizing the product. However, drying irreversibly affects the structure of the pulp. US 2006/0216393 describes a food product comprising whole vegetable or fruit pieces that have been infused with inulin and subsequently dried. US2001/012534A1 discloses a method for the preparation of a food product comprising crushing carrots, separating pomace and juice, treating the juice with acid and carbohydrate, concentrating the supernatant of the juice and blending it with the pomace, followed by drying and pulverizing or granulating the blend. WO03/088989A1 describes a method for the preparation of an edible anthocyanine-containing composition, comprising pressing plant material of fruits, vegetables, herbs or spices, separating juice and pomace, concentrating the juice and infuse the juice concentrate with the pomace portion, whereby the concentrate is absorbed into the pomace. The so-treated pomace is dried and milled to a substantially water-free (i.e. max. 3 wt % moisture) product. Since WO03/088989A1 is specifically aimed at providing products enriched with anthocyanine (sugar-bound anthocyanidine), starting materials are limited to those plants containing high concentrations of these, e.g. berries.

In the field of sugar beet extraction residues, human food applications have so far been limited to non-caloric, tasteless fillers which can be incorporated into food products to replace part of the sugar, fat or proteins. The plant residues are used as dry, ground fibre preparations without retaining the cell wall structure. For instance, U.S. Pat. No. 4,451,489 describes a bland, ground bulking agent for human food application comprising sugar beet pulp that has been subjected to bleaching and drying steps. The drawbacks of drying have been addressed before.

None of the afore-cited references—their contents herein incorporated by reference—provide a purpose to the large amounts of plant extraction residue obtained as a side-product to e.g. inulin production. Such plant extraction residues obtained after cell disruption are produced annually in massive quantities and there is a need in the art for further processing this material that would otherwise be disposed of as animal feed, feedstock for energy production, organic fertilizer or waste.

### SUMMARY OF THE INVENTION

The inventors have found that it is possible to provide food compositions from the moist residue of plant material by replacing at least part of the water contained in plant-extracted pulp with water-soluble carbohydrates and—optionally—size reduction, heating, cooking, drying and/or coating the resulting product. Preferably, at least part of the water contained in the wet/moist pulp composition is replaced with one or more soluble carbohydrate(s) selected from the group consisting of inulin, oligofructose, fructo- and/or galacto-oligosaccharide, glucose, maltose, maltodextrins, polydextrose, sucrose, fructose, lactose, isomaltulose polyols, or mixtures thereof.

With this process, food compositions can be produced that have attractive properties for human consumption, i.e. in which the ‘bite’ is maintained and any undesirable component (e.g. bitter flavours) is eliminated by (preceding) extraction. Conveniently, the pulp material otherwise regarded as waste or at most suited for incorporation in feeds thus finds use in the high-end food market. The texture or structure as it is maintained during preceding cell disruption plays an important role in the consumer's appreciation of the food composition derived from the moist plant-extracted pulp. The texture and carbohydrates optimize for desirable eating qualities such as pleasant texture, bite, chewing resistance and organoleptic properties (e.g. sweetness, lack of off-flavours, odour).

The relatively high water content of the compositions according to the invention as compared to dried and optionally comminuted pulp compositions of the art provides a texture, bite and/or chewing resistance that may range from straw-like to juicy coconut-like or candied peel. This makes them particularly attractive for application in e.g. breakfast cereals as well as cereal, granola, energy and nutritional bars and various bakery goods. Also, these residues have a high content of insoluble fibres generally believed to exert health benefits in nutrition. The combination of insoluble fibres (from the plant residue) and soluble fibres (from the water replacing carbohydrates) is most beneficial for health and well-being. Due to their water binding properties the insoluble fibres contribute to a proper defecation pattern by providing a proper faecal consistency, whereas the soluble fermentable fibres give rise to a healthy fermentation pattern in the colon (Health Council of the Netherlands (2006) Guideline for dietary fibre intake; publication no. 2006/03). This fermentation may lead to a variety of health benefits, such as improved mineral absorption, suppression of growth of potentially pathogenic bacteria, lower production of toxic fermentation metabolites or to systemic effects such as a lowered serum lipid level (relevant for heart health) or a stimulation of the immune system.

The pulp composition according to the invention can be considered as a formulation concept for dietary fibre wherein the concentrations, compositions and ratios of soluble versus non-soluble can easily be adjusted. This aids in preventing possibly unfavourable interference of soluble fibres with the method of preparation of certain foodstuffs. The pulp composition according to the invention comprising soluble fibres is an ‘inert’ formulation for soluble fibres. This aids in preventing possibly unfavourable interference of soluble fibres with the method of preparation of certain foodstuffs. This is for instance relevant in the field of bakery products, wherein soluble fibres may influence the properties of the dough and the baking properties.

Another advantage rests in the increased shelf life of the composition according to the present invention, as an affect of the decreased water activity due to the water replacement. The composition and concentration of the carbohydrates used and degree of water removal serves as a control for stickiness and shelf life. The water activity (A_{W}) of the composition is preferably below 0.8, more preferably below 0.65, most preferably below 0.60.

A production method resulting in the product according to the present invention comprises at least (i) disruption of cell membranes (to provide pulp) and (ii) replacement of water with soluble carbohydrates.

It thus diverges from the methods for processing sucrose, root-starch and inulin-rich plant material known in the art, which rely on processing the entire plant storage organ into a powder- or flour-like foodstuff with loss of tissue texture and without separate extraction of inulin, root-starch or sucrose there from. By “storage organ” it is understood any part of a plant modified for storage of energy (generally in the form of starch), nutrients or water in order to be used for future growth. Underground storage organs may be generically called roots, tubers, or bulbs. In one embodiment, these are preferred. Here, by applying only a disruption process, the treated pulp in the composition has retained the cell wall architecture (and particularly the polysaccharide-rich primary cell walls) of its undisrupted plant or vegetable counterpart. Texture and ‘bite’ are thus preserved.

The process may include the addition of humectants (e.g. salts, glycerol or short chained carbohydrates. Together with water replacement, the process thus allows for the achievement of a self-preserved product, due to controlled reduction of water activity A_{W}.

The structure of the carbohydrate-enriched plant extraction residue or pulp can be further optimized by selecting the type of crop (or organ there from) to be extracted and by adjusting the process conditions during cell disruption, extraction of the soluble ingredients or flushing out of the insoluble ingredients and during the (partial) replacement of the water by water-soluble carbohydrates and/or heat treatment or drying thereafter.

The invention also pertains to a food composition, preferably human food composition as defined in the claims and remainder of the text.

### DETAILED DESCRIPTION OF THE INVENTION

In one aspect, the invention pertains to a plant or vegetable pulp composition comprising:
a. plant or vegetable pulp containing 5-30 wt %, preferably at least 10 wt % and/or up to 25 wt % of plant cell wall materials, preferably cellulose, hemicellulose, lignin and pectin [and mixtures and/or fragments thereof], wherein said pulp is obtained by disrupting the cell membranes of vegetable or plant material, and removing at least part of the intracellular content there from;
b. 45-85 wt % of one or more water-soluble carbohydrate(s) selected from the group consisting of inulin, oligofructose, fructo- and/or galacto-oligosaccharide, glucose, maltose, maltodextrins, polydextrose, sucrose, fructose, lactose, isomaltulose, polyols, or mixtures thereof; and
c. 5-25 wt % water,
   all numbers based on total weight of said composition. As explained below, the architecture of the cell walls is to a great extent maintained in the pulp provided in step a), preferably for at least 60%, more preferably at least 70%, more preferably at least 80%, most preferably at least 90% of the plant or vegetable cells.

The pulp composition is preferably intended for use in human food applications. Applications envisaged lie mainly in the field of breakfast cereals; cereal, granola, energy and nutritional bars, baked goods, dairy, confectionery, savoury snacks, meals, pizza, pasta, processed, brine or cured meat products. Advantageously, the fresh ‘bite’ of the carbohydrate-infused/impregnated pulp and the shelf life stability may be utilized in breakfast cereals and granola bars, preferably after conversion of the carbohydrate-enriched plant residue composition into free-rolling pieces or chunks.

In another embodiment, the invention pertains to a method for the preparation of human food or pet food composition, such as the above, comprising:
a) providing a plant or vegetable pulp composition comprising water-insoluble cell wall material as is obtained by disrupting the cell membranes of vegetable or plant material, i.e. roots, tubers, fruits, seeds or vegetables and removing at least part of the intracellular content there from; and
b) replacing at least part of the water contained in the plant or vegetable pulp composition with a water-soluble carbohydrate, preferably selected from the group consisting of inulin, oligofructose, fructo-oligosaccharide, galacto-oligosaccharide, glucose, maltose, maltodextrins, polydextrose, sucrose, fructose, lactose, isomaltulose and polyols, and/or combinations thereof.

Optionally, the cell wall materials may have been subjected to hydrolysation or fragmentation.

The pulp composition thus obtained may optionally be subjected to size reduction, cooking, enzymatic liquefying, drying and/or coating etc. If desired, other ingredients for the benefit of improving flavour, colour, and/or optical appearance can be added in the process, either in step a) or b) or thereafter.

Here below, the composition of the invention is further explained in terms of the process for obtaining it.

### Step a; Plant Pulp

The terminology “plant or vegetable pulp/residue” refers to a wet or moist composition comprising predominantly cell wall materials, i.e. cellulose, hemicellulose, lignin and/or pectin (and/or fragments and/or hydrolysates), wherein the plant cell membranes are disrupted, preferably by conventional thermal, electrical and/or mechanical disruption, and wherein (at least part of) intracellular content (such as valuable edible components, such as inulin, sucrose or starch) are removed, extracted, flushed out, isolated. However, the (primary) cell wall architecture is maintained.

As used herein “pulp” is thus construed to mean the part of the vegetable or plant which is remaining when intracellular components have been (partially) removed (e.g. extracted) from the raw plant or vegetable. The pulp composition provided in step a) has not been subjected to further mechanical destruction steps, such as milling and/or grinding, and has retained the structural and textural properties associated with fibrous materials discussed above. The pulp provided in step a) is preferably low in solubles, preferably less than 5%, more preferably less than 1% of soluble solids, based on dry matter. Optionally the pulp may be reduced in size depending on the application it is ultimately used for.

In the following, the term “plant residue” or “pulp” includes residues obtained from vegetables. Preferred plant residues for use in accordance with the invention are storage organs, more preferably the wet or moist extraction residues of sugar beet, chicory root, Jerusalem artichoke tuber, fruits and vegetables (e.g. grapes, citrus, pineapple, cranberries, apple, pear, berries, carrots, potatoes, cassaya, beans) or of grains and seeds such as corn, barley, wheat or rice. The process for extracting valuable materials from these vegetable materials all yield wet or moist extraction residue compositions which are rich in insoluble cell wall components, and have varying ratios of cellulose, hemicellulose, pectins and lignins.

Most preferred plant residue compositions are those obtained from roots and/or tubers, more preferably sugar beet, chicory root and/or Jerusalem artichoke tuber, particularly chicory root and/or Jerusalem artichoke tuber. Sugar beet is a plant whose tap root contains a high concentration (15-20 wt %) of sucrose. In a standard beet sugar manufacturing process, the beet roots are washed, mechanically sliced into thin strips called cossettes, and passed to a diffuser to extract the sugar content into a water solution about 70° C. during 1.5 h. The conditions are selected for maximizing sugar yield while minimizing solubilisation of pectins from the cell walls. The spent cossettes, or pulp, exits the diffuser at about 95% moisture but low sucrose content. Using screw presses, the wet pulp is then pressed down to approx. 75% moisture. This recovers additional sucrose in the liquid pressed out of the pulp, and reduces the energy needed to dry the pulp. Chicory root and Jerusalem artichoke tuber are both well-known for their high inulin content (12-18%). Inulin extraction from chicory root and Jerusalem artichoke tuber proceeds through a process that much resembles the isolation of sucrose from sugar beets. Also the composition of pulp resulting from extracting inulin-rich plants is comparable to sugar beet extraction pulp.

In one embodiment, the plant residue compositions are obtained from carrot or fruit (after juice extraction or oil removal); potatoes or cassaya (after separation of the starch granules there from); or grains, in particular corn, barley, rice or wheat (after enzymatic solubilisation of starch there from).

The food composition comprising plant pulp prepared in accordance with the invention is characterized by having a pleasant, distinctive texture. This texture is caused by the plant cell walls comprising insoluble fibres of mainly cellulose, hemicellulose, lignin and/or pectin. Amounts and ratios between cellulose, hemicellulose, lignin and pectin depend on the plant species and on the plant part that has been processed. However, it is preferred that the dry solid composition of the plant residue composition provided in step a) contains at least 60% of the sum of these components. It is especially preferred that the composition contains at least 60 wt % cell wall components, i.e. cellulose, hemicellulose, pectin, and/or lignin based on dry weight of the composition provided in step a). It is preferred that the composition provided in step a) has a dry matter content in the range of 10-30 wt %, more preferably 20-27 wt %. The pulp may be subjected to additional (enzymatic) hydrolysis to fragment the cell wall components, in order to improve processing. Hence, the above numbers also account for cellulose, hemicelluloses, lignin and pectin hydrolysates or fragments.

Advantageously, pulp structure may be controlled by controlling both the initial thermal, electrical and/or mechanical cell disruption of the plant cell membranes and the subsequent water replacement process, as well as the heating or drying steps optionally applied after step b). In one embodiment, the desired pulp texture is attained by control of the inulin or sucrose extraction temperature for chicory root and Jerusalem artichoke tuber or sugar beet, respectively. Typical extraction temperatures for chicory root and Jerusalem artichoke tuber or sugar beet are in the range of 65-75° C., preferably 68-70° C. Extraction times are preferably between 1 and 2 hours, more preferably between 75 and 100 minutes.

The residue composition provided in step a) may be refrained from components which are undesired for subsequent incorporation in human food products. Such components may include bitter or otherwise unpleasant flavour components (e.g. typical beet flavours or the bitter constituents in chicory). These are removed during the extraction, for instance by leaching out of the pulp composition using abundant washing with water or food-grade solvents. Optionally further removal may be accomplished.

### Step b; Partial Replacement of Water: Infusion, Diffusion, Impregnation, Candying

Replacement of water in the plant residue with the soluble carbohydrate can occur by infusion, diffusion, impregnation, candying or any other technique resulting in the migration of soluble carbohydrates through the cell wall known to the skilled person. For sake of completeness it is added that the term “replacement” not necessarily means that the water is actively withdrawn, it is the physical effect of introducing soluble carbohydrates into the composition. In fact, intermediate drying between steps a) and b) to an extent of less than 10% water content, preferably to less than 15%, more preferably less than 20% is avoided. It is preferred to use conventional draining or pressing, typically resulting in a water content above 25%, more preferably above 30%. Too low water content may result in shrinking and irreversibly affect the pulp structure.

The above processes can be controlled by choosing appropriate combinations of time and temperature. The soluble carbohydrate or mixture of soluble carbohydrates is chosen such that undesirable crystallization is prevented, while at the same time desirable foodstuff qualities such as nutritiousness, sweetness, fibre content, bifidogenicity, palatability, chewability, stickiness etc. are achieved.

Many techniques are known in the art for replacing (part of) the water contained in plant residue tissue composition with soluble compounds, resulting in a product referred to herein as carbohydrate-enriched plant extraction residue. These methods preferably include infusion, diffusion, impregnation and candying of the plant tissue with a solution of the solid compounds, preferably carbohydrates, all of which are within the ambit of the skilled person.

The method preferably involves infusion and/or impregnation. Sugar and inulin infusion is for instance described in U.S. Pat. No. 4,542,033 and U.S. Pat. No. 7,118,772, herein incorporated by reference. Most preferably the method comprises impregnation. Furthermore, it is possible to gradually or stepwise increase the soluble carbohydrate concentration during the impregnation/infusion step. Such stepwise approach may be required to avoid dehydration of the pulp, resulting in irreversible adverse effects on eating properties.

### Soluble Carbohydrates

The soluble carbohydrates applied for replacing at least part of the water contained in the pulp composition are chosen from the group consisting of inulin, oligofructose, fructo- and/or galacto-oligosaccharide, glucose, maltose, maltodextrins, polydextrose, sucrose, fructose, lactose, isomaltulose and polyols. With the addition of fructose or sucrose the sweetness can be optimised. By using polyols, such as sorbitol or mannitol, the caloric content may be influenced as well as the glycemic response. Such polyols, including glycerol can also be used to affect the A, value to obtain the proper shelf life of the product.

In one embodiment, water is replaced with fruit-derived sugars, for instance provided as fruit juice (such as apple juice concentrate). In other words, at least part but preferably all of the water-soluble carbohydrates are provided for by fruit juice or concentrate.

In one embodiment, the soluble carbohydrates contain at least or consist of indigestible oligosaccharides, preferably having a DP between 2 and 100, and/or more preferably selected from the group consisting of inulin, oligofructose, fructooligosaccharides and galactooligosaccharides, most preferably inulin, fructooligosaccharide and/or oligofructose. Using inulin or galacto-oligosaccharides will lead to a product with bifidogenic and related health properties, and with these soluble carbohydrates a desired ratio of insoluble/soluble fibre and therewith associated nutritional profile. Inulin and fructo-oligoaccharides also offer the advantage that they may mask off-flavours in the product, enhance sweetness or improve taste perception.

The concentration of the soluble carbohydrate or the mixture of soluble carbohydrates and the processing time and temperature are chosen such that unwanted crystallization is prevented and a desired water activity (Aw) of the resulting food ingredient is achieved. It is preferred that the concentration of soluble carbohydrates in the solution used for treating the pulp lie within the range of 200 to 800 mg/ml, more preferably 600 to 750 mg/ml The infusion, diffusion, impregnation or candying step is preferably performed until an equilibrium of carbohydrate concentration in- and outside the pulp is established. This may vary upon pulp particle size, temperature, carbohydrate concentration and composition (e.g. molecular weight). It may vary from few minutes at 80° C. to several days in cold storage.

In another embodiment of the invention, dry carbohydrates or mixtures thereof are added to the moist pulp, and equilibrium is achieved by choosing appropriate temperature/time combinations.

With “replacing at least part of the water contained in the extraction residue composition” it is preferred that at least 40 wt %, more preferably at least 50 wt %, most preferably at least 60 wt % of the water initially present in the extraction residue composition is replaced with soluble carbohydrates. In one embodiment, it is preferred that 45-85 wt % of the water is replaced with soluble carbohydrates.

It is preferred that the plant or vegetable pulp composition contains 50-85%, more preferably 55-80 wt % of soluble carbohydrates, based on total weight of the composition. Although these numbers apply to the total content of soluble carbohydrates in the pulp composition, the contribution of soluble carbohydrates provided for by the extracted pulp is little. In essence, the carbohydrates are obtained from the replacement (e.g. infusion) step.

In a preferred embodiment, the inulin, fructooligosaccharide and/or oligofructose applied for replacing at least part of the water contained in the pulp composition originates from chicory root. These inulin, fructooligosaccharide and/or oligofructose components may differ in size distribution, ratios etc. from the carbohydrate composition originally present in the plant, vegetable, fruit etc. tissue prior to extraction of the carbohydrate there from.

### Auxiliary Agents

In another embodiment, further agents may be added to improve palatability, optical appearance, shelf-life, processability, nutritiousness etc. These may include salt, flavourings, fragrances, colorants, preservatives, vitamins, antioxidants, etc. Such auxiliary agents may be added directly to the carbohydrate solution, or may be added after step b).

### EXAMPLES

### Example 1

### Sugar Beet Pulp

5 kg of sugar beets were cleared from attached soil residue and subsequently minced into small chips of about 2-5 mm using a Hobart model 84145 cutter. To extract sucrose and other soluble components from the chips, these were immersed in a large quantity of water at 60° C. for around 90 minutes. The chips were drained and as much as possible of the remaining water pressed out according to industrial practice. After pressing, the pulp had a dry matter content of approximately 25 wt %.

The remaining moist pulp was immersed in a liquid composition comprising about 50 wt % water, 25 wt % oligofructose (Frutalose™ LF92) and 25 wt % High Glucose syrup at about 60° C. for two hours. The product was drained on a screen and subsequently immersed in a syrup mixture of 50 wt % oligofructose (Frutalose™ LF92) and 50 wt % High Glucose syrup. The temperature was maintained at 60° C. and processing time was about 2 hours. In order to remove residual syrup the product was drained on a screen and pressed in a Hafico model HP-2H tincture press.

The resulting product has a pleasant mouth feel and a sweet flavour. Earthy off-flavours that are commonly associated with products derived from sugar beet were absent.

### Example 2

### Chicory Root Pulp

About 5 kg of chicory root tubers were treated and extracted according to example 1.

The syrup used to replace the water in the chicory root extraction pulp was a 50/50 (wt/wt) mixture of oligofructose (Frutalose™ L92) and a high maltose syrup (Glucomalt 560™ from Syral). Similar to example 1 the replacement of the water with syrup was performed in two stages, first using a 50/50 mixture of syrup and water and secondly immersing in syrup only. After each stage residual syrup was removed in the same manner as in example 1.

The finished product has a pleasant, crisp bite and lacks the bitter off-flavours commonly associated with chicory root.

### Example 3

### Carrot Pomace

Pomace residue from the extraction of carrot juice was immersed in oligofructose Frutalose™ L92 syrup for 6 hours while the temperature was maintained at 60° C., thus allowing the water migrating from the pomace into the syrup to evaporate. The carbohydrate-infused product was formed into cubicles by sheeting and cutting.

### Example 4

### Cereal Bar with Chicory Pulp

The infused chicory pulp was prepared as described in example 2, except that after the second stage the syrup was not removed.

A mixture was prepared with:

80% infused chicory pulp with syrup

12% oligofructose Frutalose™ L92,

4% fat,

0.4% emulsifier,

1.5-2.0% glycerol.

The ingredients were cooked together till a dry substance is obtained of 85%.

After cooking, this material was pressed at a temperature of 40° C. using a press machine applying 100-150 bar to separate the binding syrup (a) and the insoluble fibre (b).

Production of a Cereal Bar:

Ingredients:

20% binding syrup (a),

30% pressed insoluble fibre (b), and

50% cereal mix (65 parts of oat flakes, 25 parts of rice crisps and 10 parts of dried fruit pieces)

flavour

The ingredients were mixed together at 60° C. using appropriate mixing equipment.

After mixing, the whole mass was sheeted to a certain thickness using rollers. The mass was cooled via a cooling tunnel commonly used in granola bar manufacturing, cut into individual bars and packaged individually in an appropriate packaging.

### Example 5

### Infused Chicory Pulp in Muffins

Sample: Infused Chicory Pulp

Chicory pulp was infused with glucose syrup (Type: Glucor 60-80, supplier: Pfeifer and Langen), oligofructose (Type: Frutalose L 92, supplier: Sensus) and 1% glycerol.

Recipe Muffin Batter:

500 g SuMix Multi (Supplier: Unifine Food & Bake Ingredients)

200 g Tap water

200 g Sunflower oil

60 g Infused chicory pulp (=6.25% of the total batter mass)

Preparation method muffins:
Mix all ingredients 5 minutes in a Hobart mixer (type N-50) on stage 1 with a flat beater.
Add the Infused Chicory pulp and mix 20 seconds on stage 1.
Weigh out 60 g. of batter in paper muffin cups.
Decorate with Infused Chicory pulp on top batter. (3.5 g per muffin)
Bake 25 minutes at 200° C. in an electric heated oven. (type: Miwe Condo)

Results:

| Bake stability: | Infused chicory pulp pieces are bake stable in | |
|---|---|---|
| | muffins, inside as well as on top | |
| Performance: | In muffin: | slightly brown coloured, glossy |
| | On top muffin: | light till dark brown coloured |
| Taste: | A good taste, no bitter aftertaste | |
| Bleeding: | No bleeding | |
| Eating properties: | In muffin: | good, pleasant firm bite. |
| | On top muffin: | Judged as fresh: hard, crunchy pieces |
| | | Judged after 1 day: soft with a firm bite |

| | |
|---|---|
| Advantages: | Healthy, artisan image, fibre enrichment |

1. A plant or vegetable pulp composition comprising:
a. plant or vegetable pulp comprising 5-30 wt % cell wall materials comprising cellulose, hemicellulose, lignin and/or pectin, and/or fragments and/or hydrolysates thereof, wherein said pulp is obtained by disrupting plant or vegetable cell membranes and removing at least part of the intracellular content;
b. 45-85 wt % of one or more water-soluble carbohydrate(s) selected from the group consisting of inulin, oligofructose, fructo-oligosaccharide, galacto-oligosaccharide, glucose, maltose, maltodextrins, polydextrose, sucrose, fructose, lactose, isomaltulose and polyols, and/or combinations thereof; and
c. 5-25 wt % water,
(all percentages based on total weight of said composition).

2. The composition according to claim 1, wherein the architecture of the cell walls is maintained, in case of in at least 60% of the cell membranes.

3. The composition according to claim 1, wherein said pulp is obtained from chicory root, sugar beet, Jerusalem artichoke tuber, carrot, potato, grains and/or fruit.

4. The composition according to claim 1, wherein said pulp is obtained from tubers and/or roots.

5. The composition according to claim 1, wherein said one or more water-soluble carbohydrate(s) comprise non-digestible oligosaccharides.

6. The composition according to claim 1, wherein at least part of said one or more water-soluble carbohydrate(s) is provided for by fruit juice or concentrate.

7. (canceled)

8. The composition according to claim 1, comprised in a food product.

9. The composition according to claim 8, said food product being a human food product.

10. The composition according to claim 9, said human food product being breakfast cereals or cereal bar, baked goods, dairy, confectionery, savoury snacks, meals, pizza, pasta, processed, brined or cured meat products.

11. A method for the preparation of a plant or vegetable pulp composition comprising 5-25 wt % water, the method comprising:
a. providing plant or vegetable pulp comprising cell wall materials comprising cellulose, hemicellulose, lignin and/or pectin, and/or fragments and/or hydrolysates thereof, wherein said pulp is obtained by disrupting plant or vegetable cell membranes and removing at least part of the intracellular content; and
b. replacing at least part of the water contained in the plant or vegetable pulp with a water-soluble carbohydrate to obtain the pulp composition.

12. The method according to claim 11, in which step b) is performed by infusion, diffusion, impregnation or candying.

13. The method according to claim 11, in which the plant or vegetable pulp in step a) is obtained from chicory root, sugar beet, Jerusalem artichoke tuber, carrot, potato, grains and/or fruit.

14. A food comprising the plant or vegetable pulp composition according to claim 1.

15. The food according to claim 14 being selected from the group consisting of breakfast cereals or cereal bar, baked goods, dairy, confectionery, savoury snacks, meals, pizza, pasta, processed, brined or cured meat products.

16. The method according to claim 14, wherein the water-soluble carbohydrate comprises inulin, oligofructose, fructo-oligosaccharide, galacto-oligosaccharide, glucose, maltose, maltodextrins, polydextrose, sucrose, fructose, lactose, isomaltulose and polyols, and/or combinations thereof.

17. The method according to claim 12, in which step b) is performed by impregnation.

18. The method according to claim 11, further comprising subjecting the pulp composition to size reduction, cooking, enzymatic liquefying, drying and/or coating.

19. The composition according to claim 4, wherein said tubers and/or roots comprise sugar beet, chicory and/or Jerusalem artichoke.

20. The composition according to claim 5, wherein said non-digestible oligosaccharides comprise inulin, oligofructose and/or fructo-oligosaccharides.
